(19) United States
(12) Patent Application Publication
(10) Pub. No.: US 2007/0283039 A1
(43) Pub. Date: Dec. 6, 2007

(54) MAIL APPLICATION WITH INTEGRATED TEXT MESSAGING FUNCTIONALITY

(75) Inventors: Ben Kim, Sunnyvale, CA (US); Naveen Dasa Sanjeeva, Milpitas, CA (US); Kevin Brown, Sunnyvale, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/422,540

(22) Filed: Jun. 6, 2006

(51) Int. Cl. G06F 15/173

(52) U.S. Cl. 709/238

(57) ABSTRACT

A network device, method, and mobile device are directed towards enabling a user to compose a message using an email interface, and then to send the message to a recipient as a text message. The message is automatically converted into one or more SMS, EMS, MMS messages, or the like. In addition, any attachments in the message may be converted to a URL link the enables the recipient to access the attachment. When the user sends the text message, a copy of the message may be placed in the user's email sent folder. If a response is received as a text message, it may be converted to an email message. In addition, the response message may be moved to the user's email inbox folder. A notification of its receipt may also be provided to the user through the email interface.

### FIELD OF THE INVENTION

The invention relates generally to communications over a network, and more particularly but not exclusively to integrating automatic text messaging functionality with an email application to communicate with a mobile device.

### BACKGROUND OF THE INVENTION

In today's computing environment, a user may employ a variety of computing devices. For example, one user may use a desktop personal computer (PC) at a fixed work place, at home, or the like, while another user may use a mobile computing device, such as a cellular telephone, a palm-size PC, or perhaps even a personal data assistant (PDA).

Moreover, users may further employ a variety of communication modes. For example, users may communicate using email messages, audio messages, Voice over Internet Protocol (VOIP), Short Message Services (SMS), Instant Messaging (IM), or the like. Email messaging, for example, provides a convenient mechanism for a peer to peer type of communication. But, a user may not know when the recipient will read the email message. While the user might select then to employ a different communication mode, tracking and coordinating of messages to other users may then become confusing. Thus, it is with respect to these considerations and others that the invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the invention, reference will be made to the following Detailed Description of the Embodiments, which is to be read in association with the accompanying drawings, wherein:

FIG. 1 shows a functional block diagram illustrating one embodiment of an environment;

FIG. 2 shows one embodiment of a client device that may be employed in a system implementing the invention;

FIG. 3 shows one embodiment of a network device that may be employed in a system;

FIG. 4 illustrates a logical flow diagram generally showing one embodiment of a process for text messaging functionality integrated with email messaging functionality to send a message to a mobile device;

FIG. 5 illustrates a logical flow diagram generally showing one embodiment of a process for integration of text messaging functionality with email messaging functionality for receiving of a message from a mobile device; and

FIG. 6 shows one embodiment of an email interface that may be employed in practicing the invention, in accordance with various embodiments.

### DETAILED DESCRIPTION OF THE INVENTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods or devices. Accordingly, the invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “protocol” refers to the format and procedures that governs the transmitting and receiving of data.

The term “automatically” refers to an action that is performed by a computing device without additional interactions by a user.

The term Short Message Service (SMS) refers to a communication mechanism for providing connectionless transfers of limited size messages between networked devices. SMS messages may be cell broadcast services which are periodically delivered short message to a pre-defined set of computing devices in a given area, or point-to-point services which include short messages sent to a specific user. The SMS protocol is described in more detail in International Standard ISO/IEC 21989, as well as such documents as Global System for Mobile Communications (GSM) 03.38 and 04.11. As used herein, SMS refers to all such Short Message communications, and those derived therefrom.

As used herein, the terms “text messaging,” or “text message” refer to SMS messaging, as well as a variety of other limited size message protocols, including, but not limited to Multimedia Messaging Service (MMS) message, or an Enhanced Message Service (EMS) message protocols.

Briefly stated, embodiments are directed towards enabling a user to compose a message using an email interface, and then to select to send the message to a recipient as a text message. The message may be automatically converted into one or more text messages, based, in part, on its length. In one embodiment, the text message may be converted to at least one SMS message, MMS message, or an EMS message format. In addition, any attachments in the message may be converted to a URL link that enables the recipient to access the attachment. When the user sends the text message, a copy of the message may be placed in the user's email sent box, or outbox or folder. If a response is received as a text message, it may be automatically converted to an email message. In addition, the response message may be moved to the user's email inbox folder. A notification of its receipt may also be provided to the user through the email interface. In one embodiment, the user may send text messages through the email interface to a plurality of potential recipients. Moreover, in one embodiment, the email interface may provide a tab mechanism, or the like, that enables ready access to one of a plurality of resulting conversations. Using a tab mechanism, notification of a receipt of a message may be performed by highlighting a respective tab, blinking the respective tab, changing a color of the respective tab, or the like.

### Illustrative Operating Environment

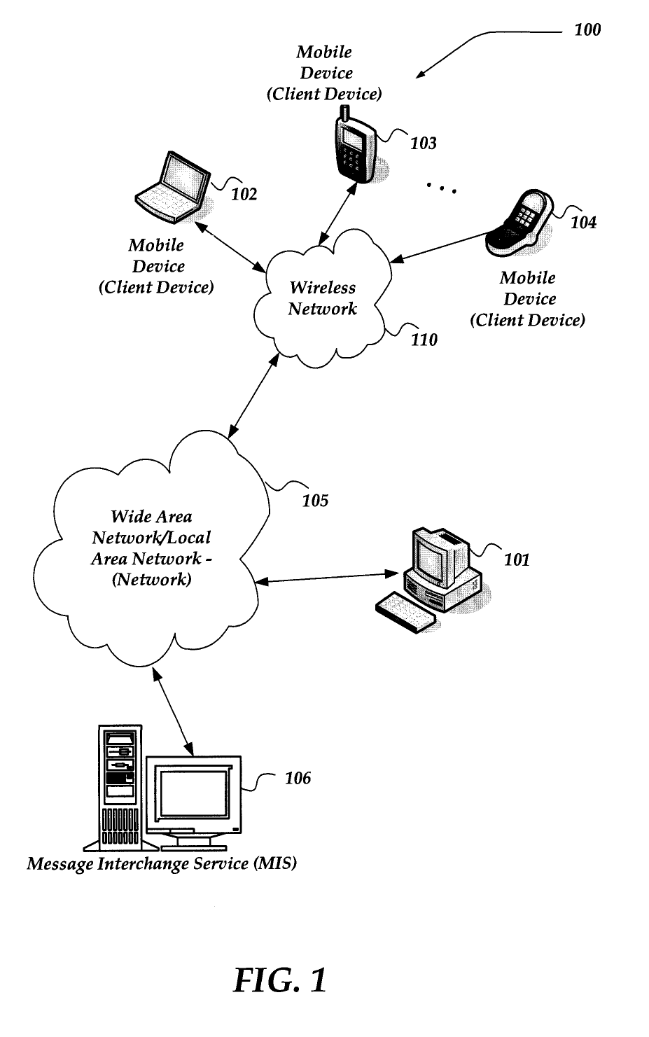

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 110, Message Interchange Service (MIS) 106, client devices 101-104. As shown, client devices 102-104 represent various embodiments of mobile devices.

Generally, client devices 101-104 may include virtually any computing device capable of receiving and sending a message over a network, such as network 105, wireless network 110, or the like, to and from another computing device, such as MIS 106, each other, or the like. Client device 101 may include devices that typically connect using a wired communications medium such as personal computers, multiprocessor systems, microprocessor-based or programmable consumer electronics, network PCs, and the like. Client devices 102-104 may include devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Client devices 102-104 also may be any computing device that is capable of connecting using a wired or wireless communication medium such as a PDA, POCKET PC, laptop computer, wearable computer, mobile phone and any other device that is equipped to communicate over a wired and/or wireless communication medium.

Client device 101 may include a browser application that is configured to receive and to send web pages, web-based messages, and the like. The browser application may be configured to receive and display graphics, text, multimedia, and the like, employing virtually any web based language, including Standard Generalized Markup Language (SMGL), HyperText Markup Language (HTML), eXtensible Markup Language (XML), and so forth. Similarly client devices 102-104 may also include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Client devices 101-104 may also be configured to communicate a message, such as through Short Message Service (SMS), Multimedia Message Service (MMS), instant messaging (IM), internet relay chat (IRC), Mardam-Bey's IRC (mIRC), Jabber, email, and the like, between another computing device, such as MIS 106, each other, or the like. However, embodiments are not limited to these message protocols, and virtually any other message protocol may be employed. For example, client devices 101-104 may also be enabled to communicate an audio message using Voice over Internet Protocol (VOIP), or the like.

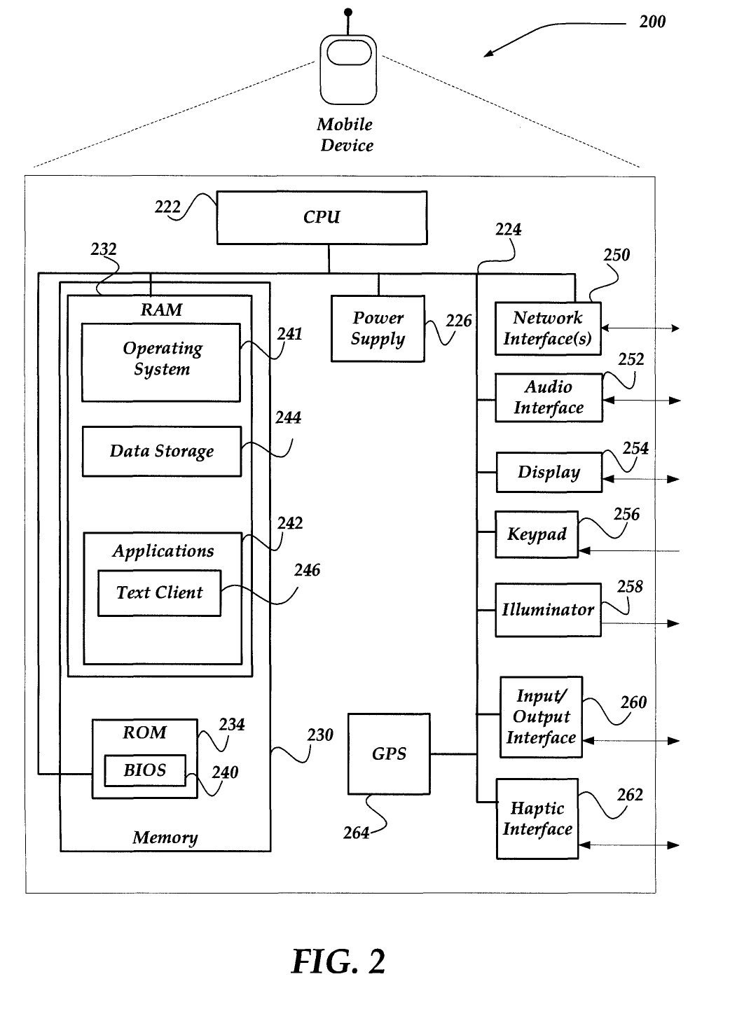

One embodiment of mobile devices (client devices) 102-104 is described in more detail below in conjunction with FIG. 2. Generally, however, mobile devices 102-104 may include virtually any portable computing device capable of receiving and sending a message over a network, such as network 105, wireless network 110, or the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

Mobile devices (client devices) 102-104 also may include at least one other client application that is configured to provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to MIS 106, client device 101, or other computing devices.

Client devices 101-104 may further be configured to include a client application that enables the end-user to log into an end-user account that may be managed by another computing device, such as MIS 106, or the like. Such end-user account, for example, may be configured to enable the end-user to receive and/or send email messages, SMS messages, audio messages, or the like. However, in one embodiment, communications with another computing device may also be performed without logging into the end-user account.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices 102-104 and another computing device, network, and the like.

Moreover, one or more components within wireless network 110 may be managed by one or more carrier service providers that are configured to manage various aspects of the communications.

Network 105 is configured to couple MIS 106 and its components with other computing devices, including, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between MIS 106, client device 101, another network, and/or other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

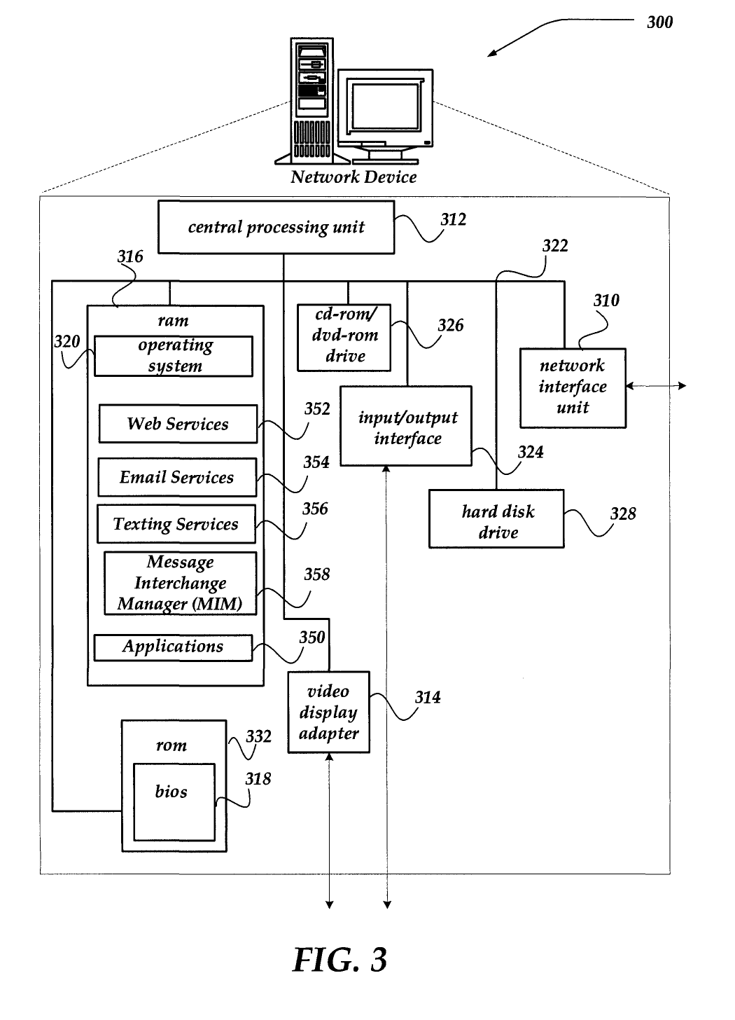

One embodiment of MIS 106 is described in more detail below in conjunction with FIG. 3. Briefly, however, MIS 106 may include any computing device capable of connecting to network 105 to enable a selective interchange of messages between computing devices. MIS 106 may enable a user of a computing device to compose a message using, for example, an email interface, and then select to send the message as a text message, or the like. In one embodiment, based, in part, on a destination address for the message, MIS 106 may automatically convert the message from an email message to one or more SMS messages, MMS messages, or EMS messages. For example, in one embodiment, if the destination address of the message is a mobile device, MIS 106 may automatically convert the email message to one or more SMS messages.

MIS 106 may further enable storage, alerting, tracking, and similar management activities of the communicated message, and/or a corresponding response message.

In one embodiment, MIS 106 may provide a user email interface for use in managing messages. Such email interface may, for example, include a web browser interface that enables access to an email inbox, outbox, sent box, or the like. MIS 106 may also be configured to interact and provide message information to an email client that may reside on a client device, such as client devices 101-104. Devices that may operate as MIS 106 include personal computers desktop computers, multiprocessor systems, microprocessor-based or programmable consumer electronics, network PCs, servers, and the like.

Although FIG. 1 illustrates MIS 106 as a single computing device, the invention is not so limited. For example, one or more functions of MIS 106 may be distributed across one or more distinct computing devices. For example, managing various messaging activities, including Instant Messages (IM), text messages, email messages, and selective message interchanges, may be performed by a plurality of computing devices, without departing from the scope or spirit of the various embodiments.

### Illustrative Mobile Client Environment

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the invention. Mobile device 200 may represent, for example, client devices such as mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. For example, although not shown, mass memory may also include a disk drive, or the like. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like. Data storage 244 may also store information that uniquely identifies mobile device 200 including a phone number, a Mobile Identification Number (MIN), an electronic serial number (ESN), Mobile Station International ISDN Number (MSISDN), or other mobile device identifier. Moreover, data storage 244 may also be employed to store messages, an address book, phone list, task lists, or the like.

Applications 242 may include computer executable instructions which, when executed by mobile device 200, transmit, receive, and/or otherwise process messages (e.g., MMS, IM, EMS, email, and/or other messages), audio, video, and enable telecommunication with another user of another client device. Other examples of application programs include calendars, browsers, email clients, IM applications, VOIP applications, contact managers, task managers, transcoders, database programs, word processing programs, security applications, spreadsheet programs, games, search programs, and so forth. One example of an application shown in FIG. 2 is Text client 246.

Text client 246 enables mobile device 200 to receive and/or send text messages to another device. In one embodiment, Text client 246 may also provide an alerting mechanism that indicates to a user of mobile device 200 when a text message is received. Text client 246 may also allow the user to compose a text response message, and to send the text response message over a network. Text client 246 may operate to manage SMS text messages, MMS messages, EMS messages, or the like.

### Illustrative Server Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, MIS 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, content delivery programs, account management, and so forth. Application programs may also include web services 352, email services 354, Texting services 356, and Message Interchange Manager (MIM) 358.

Web services 352 are configured to manage requests from a client device's browser application and deliver web-based content in response. As such, web services 352 may include such applications as Apache, Internet Information Server (IIS), Netscape, National Center for Supercomputing Applications (NCSA), or the like. In one embodiment, web services 352 communicate with the client's browser application employing HTTP. However, web services may also execute server-side scripts (CGI scripts, JSPs, ASPs, and so forth) that provide functions such as database searching, e-commerce, and the like.

In one embodiment, web services 352 interacts with other message services, such as email services 354, Texting services 356, or the like, as well as MIM 358 to enable interchange of messages. In one embodiment, therefore, web services 352 may enable messages that are sent and/or received to be accessed through a client's browser.

Email services 354 are configured to enable a user to receive and/or send email messages to another user. In one embodiment, email services 354 may interact through a user interface, or other client application, to enable a user to compose, send, receive, and otherwise manage email messages.

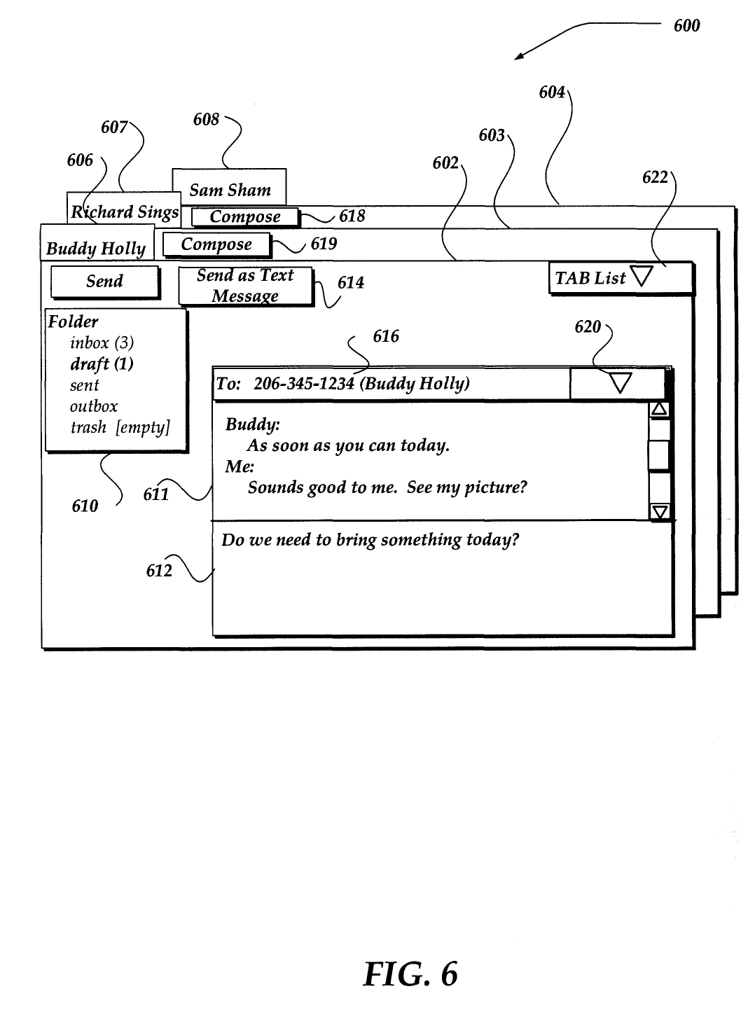

In one embodiment, web services 352 may be configured to provide the user with an interface to email services 354. Alternatively, web services 352 may operate with its own email service components to enable web-based mailing of email messages. Examples, of such web-based email services include, but are not limited to hotmail.com, juno.com, mail.com, yahoo.com, and the like. One embodiment of a user email interface employing a tab mechanism is described in more detail below in conjunction with FIG. 6.

Email services 354 may further interact with MIM 358 to enable at least some email messages to be converted into text messages. Such conversion may be based on a variety of criteria, including, but not limited to, a user selection to convert the email message, a destination computing device type and/or capability, or the like. In one embodiment, conversion between email messages and text messages may be automatically performed based on whether the destination computing device is capable of receiving text messages, and whether the destination computing device's service provider, carrier, or the like, is capable of providing text messages.

Email services 354 may be further configured to move messages into various folders, sometimes called boxes, based on a variety of criteria. For example, email services 354 may move a composed message to an outbox when a user selects to have the message sent to a destination. When the message is sent, email services 354 may also enable the message to be copied into a sent box for the user to be able to access. Similarly, email services 354 may also move received messages into an inbox when a message is received. In one embodiment, email services 354, may further provide an alert, such as a sound, window, screen display, or the like, to indicate that a message is received.

Email services 354 may also be configured to operate to hold the received email messages for a user. Email services 354 may operate according to the POP (Post Office Protocol) protocol or alternatively according to the IMAP (Internet Message Access Protocol) protocol. However, email services 354 are not limited to these protocols, and others may be employed without departing from the scope or spirit of the invention.

In one embodiment, email services 354 may employ an account for a user that enables the user to manage their messages on network device 300, or another computing device. Email services 354 may also interact with an email client application on the user's computing device. The email client application may be a software program for communicating with the email server in order to download email messages, and then for displaying those email messages to the user. The email client application may also communicate with the email services 354 according to the POP, IMAP protocol, or the like, for receiving email messages, and SMTP (Simple Message Transfer Protocol) for sending (or forwarding) email messages.

Such email messages are typically encoded in q standard MIME multi-part message format, which enables the message to optionally also include one or more attachments. Each part of the multi-part message may be separately and differently encoded, for example, for plain text messages, as opposed to attached word processing documents, image files, video data, audio data, and so forth. Such a multi-part message may be of varying size based, in part, on the size of the attachment(s).

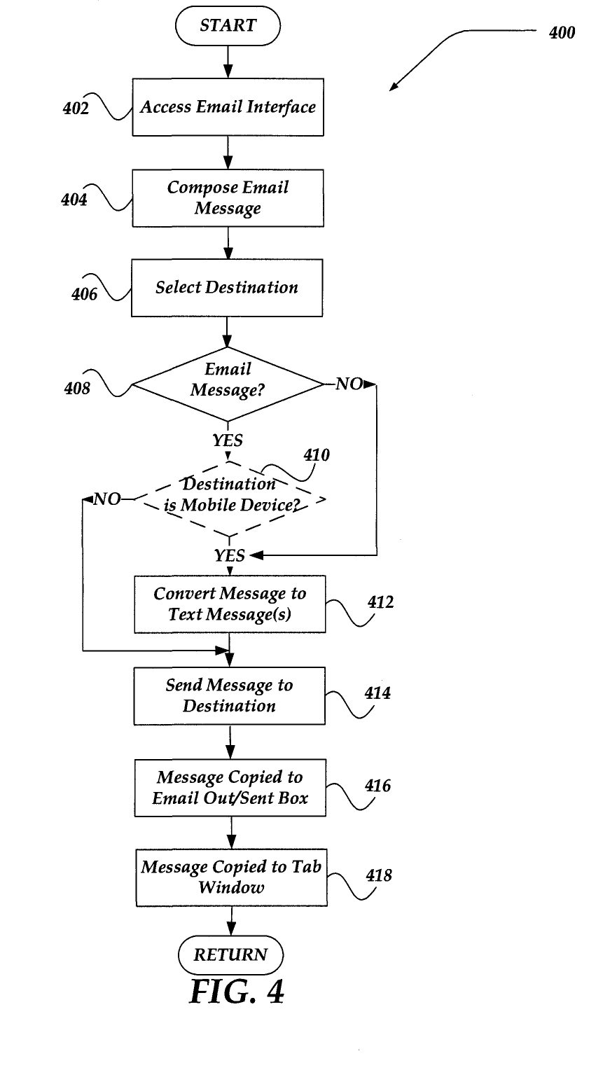

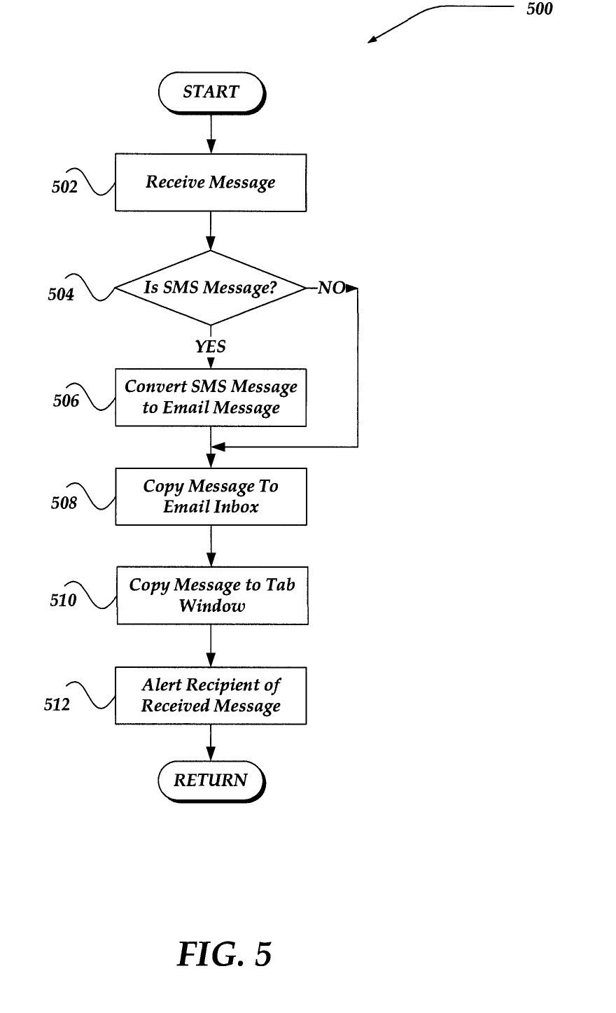

MIM 358 is configured to interact with email services 354, Texting services 356, and the like, to enable email messages to be converted into text messages, and similarly, for text messages to be converted into email messages. Moreover, MIM 358 may provide a tag, or other identifier with the messages to indicate that the message is a converted message, such that another service, such as email services 354, Texting services 356, or the like, forwards the message to MIM 358. When a response is received to a converted text message, MIM 358 may also convert the response into an email format for management through email services 354. MIM 358 may also be configured to perform at least some of its actions, in one embodiment, using processes such as described below in conjunction with FIGS. 4-5.

MIM 358 may also employ a data store that includes information about a destination address. Such information may include, but is not limited to a user name, a device type, a device capability, a carrier, a service provider, or the like. The data store may be managed by MIM 358, or another service, such as email services 354, web services 352, a service provider, carrier, or the like. Moreover, the data store may be a plurality of data stores managed by a variety of different services.

Texting services 356 are configured to manage receipt and transmission of text messages, such as SMS messages, EMS messages, MMS messages, or the like. In one embodiment, Texting services 356 may receive the message from MIM 358. Texting services 356 may then prepare the message by adding headers or the like, to indicate a source and/or destination of the message. In one embodiment, when a user requests that a text message be sent to a mobile device destination, Texting services 356 may prepare and send the message to a Short Message Service Center (SMSC) provider, or similar service center. The SMSC, or the like, may then employ a variety of mechanisms to locate the destination device.

Texting services 356 may prepare the text message to be sent to a destination employing a common short code (SC), sometimes known as simply a short code. Briefly, short codes are short strings of numbers to which a text message may be addressed and includes a common addressing scheme for participating wireless networks. Short codes may be assigned to a designation, an origin, or the like. For example, in one embodiment, Texting services 356 may have assigned to itself, a short code of “92466.” However, it is clear that Texting services 356 may employ virtually any message origin identifier. For example, Texting services 356 may employ an Internet Protocol (IP) address, and the like. Thus, while short codes are described, the invention is not so limited.

Texting services 356 may be further configured to enable a use of short code extensions, or simply “extensions,” to indicate, at least in part, a destination and/or origin for the text message. Briefly, such “extensions” may include virtually any alpha character, numeric character, symbol, and/or any combination of alpha, numeric, and/or symbols. For example, Texting services 356 may employ a numeric range of numbers, such as from ‘101’ to ‘400,’ to indicate a source of the message. In one embodiment, Texting services 356 may further employ information within a contact list, email address book, or the like, to determine an extension. For example, Texting services 356 may determine if the sender of the message is within a contact list, address book, buddy list, or the like, associated with the destination user. Extension may also be employed to identify a sender that may not be in a contact list, buddy list, address book, or the like of the destination user. Texting services 356 may assign an extension based on the sending user's information within the contact list, address book, buddy list, or the like. Thus, in one embodiment, Texting services 356 may send the reformatted message to the destination address, as a text message indicating that the message is from “92466” with an extension that indicates that the sender is identifiable within the destination user's contact list, or the like. However, the invention may employ any of a variety of mechanisms to identify the sender of the message, and is not constrained to this example.

Mapping of the SC and/or extensions may be performed using a data store within or managed by Texting services 356, or even another service.

Texting services 356 may also, in one embodiment, employ a wakeup alert, to wakeup the text client application on the destination computing device, such that the destination user may be alerted to having received a text message. In this manner, various embodiments may provide timely messages between computing devices.

If Texting services 356 receive the text message through MIM 358, the message may be tagged, or otherwise identified as being associated with an email service. As such, if Texting services 356 receive a response to the message, Texting services 356 may provide the response message to MIM 358 for additional processing.

### Generalized Operation

The operation of certain aspects of the embodiments will now be described with respect to FIGS. 4-5. FIG. 4 illustrates a logical flow diagram generally showing one embodiment of a process for text messaging functionality integrated with email messaging functionality to send a message to a mobile device. Process 400 of FIG. 4 may be implemented within MIS 106 of FIG. 1.

As shown, process 400 begins, after a start block, at block 402, where a user may select to access an email interface. As mentioned above, the email interface may be a web browser, an email client application such as Outlook®, Thunderbird, Eudora, Mozilla mail, Ximian Evolution, mutt, pine, or virtually any other mail user agent interface.

Process 400 then proceeds to block 404 where the user may compose an email message. Composing the email message may include entering of a character, text, or other data, into a message body. The user may also provide attachments within the email message, or provide a subject text, or the like.

Processing flows next to block 406 where the user may select a destination address for the message. In one embodiment, the user may select a destination address from an address book, contact list, or the like. In one embodiment, as the user enters the destination address, a list of matching entries may be provided from which the user may employ to auto-complete the destination address. In one embodiment, the user may enter a user name, alias, an email address, an SMS address, a telephone number, or the like, as the destination address.

Processing then continues to decision block 408, where a determination is made whether the user selects to send the composed message as an email message, or to have the email message converted to a text message. The user may, for example, select to have an email converted to a text based on a timeliness of the message. For example, the user may want to send an urgent message, receive a prompt response, or the like. If the user selects to have the email message converted to a text message, processing flows to block 412; otherwise, processing continues to optional decision block 410.

It is noted that while process 400 illustrates decision block 408 being performed subsequent to blocks 404 and 406, the invention is not so constrained. Thus, for example, in one embodiment, the decision to send a message as an email message or as a text message (decision block 408) may be performed prior to block 404, between blocks 404 and 406, or concurrent with block 404, block 406, or the like. For example, during composition of a message, the user may select a destination address, or even select to have the message sent as a text message. The user may then return to composing the message, or the like. Where the decision to convert to a text message is made earlier in the process, block 412 may also be performed sooner. Thus, it is apparent that the invention is not constrained to a purely sequential flow of actions as illustrated in FIG. 4.

Proceeding to optional decision block 410, the email message may automatically be converted to a text message based on the destination address. For example, in one embodiment, if the destination address indicates that the destination device is a mobile device that is capable of receiving a text message, processing may flow to block 412. Such determination may be made based on a variety of mechanisms. For example, a data store, address book, or the like, may include information about the destination address that includes whether the destination address is associated with a mobile device. Moreover, in one embodiment, a determination may also include whether the destination address is associated with a mobile device that is capable of receiving a text message, whether an associated carrier or service provider to the destination address is configured to provide text messages, or the like. In any event, if the destination address is not associated with a mobile device or the carrier is unable to provide text messages, processing may branch to block 414.

At block 412, the email message is converted to a text message, such as an SMS, EMS, MMS message, or the like. It is recognized that payloads lengths of a text message typically are constrained based on various signaling protocols, or other factors. For example, an SMS message payload may be limited to 140 bytes. In practice, this typically translates to either 160 7-bit characters, 140 8-bit characters, or 70 2-byte characters in languages such as Arabic, Chinese, Korean, Japanese, or some Slavonic languages. Routing data and other metadata may be additional data.

However, larger content, sometimes known as long or concatenated SMS, may be sent segmented over multiple messages. Such multiple messages may employ a user data header (UDH) that identifies segmentation information. Therefore, larger email messages may be readily segmented into multiple shorter text messages during their conversion.

Moreover, some carrier service providers for text messaging may be unable to include such content as images, graphics, or the like within their text messages. Thus, in one embodiment, if the email includes such content, attachments, or the like, conversion may include adding a URL link, or the like, to the text message that enables a recipient to access the content. In one embodiment, for example, the content may be stored at a server location. The URL may then provide a link to that location. When the recipient selects the URL, the content may be downloaded to the recipient's device. In one embodiment, selection of the URL may also result in opening a web browser, or other client application, on the recipient's device, in which the content may then be viewed, or otherwise accessed. However, in one embodiment, where the carrier service provider, and a receiving computing device, is capable, binary content, such as ringtones, logos, images, or the like, may be included within one or more text messages. For example, in one embodiment, a text messaging protocol such as MMS may be employed as MMS is an example of a text messaging protocol designed for such binary content. However, other text messaging protocols may also be used.

Processing then continues to block 414, where the message(s) are sent towards the destination using such as email messaging protocols, web-based protocols, and/or text based protocols. For example, where the message is an SMS message, the message may be sent via a store-and-forward mechanism to a Short Message Service Center (SMSC), or the like, which attempts to send the message to the recipient. Transmission of the text message may employ a variety of mechanisms, including, for example, Signaling System 7 (SS7) within a GSM (Mobile Application Part) MAP framework, American Standards Institute ANSI-41 protocol, or the like.

Process 400 then flows to block 416, where the message may also be copied to the user's email outbox and/or sent box. By providing the message to the user's email out and/or sent box, the user is able to view and manage the message using the same email interface, independent of the protocol employed to send the message. Processing flows next to block 418, where the message may also be copied to a tab window that is associated with a conversation with the destination. In this manner, a history of the correspondences with the destination may be viewed. Processing then returns to a calling process to perform other actions.

FIG. 5 illustrates a logical flow diagram generally showing one embodiment of a process for integration of SMS message functionality with email messaging functionality for receiving of a message from a mobile device. Process 500 of FIG. 5 may be implemented within MIS 106 of FIG. 1, for example.

Process 500 begins, after a start block, at block 502, where a message is received at a server device. Processing then proceeds to decision block 504 where a determination is made whether the received message is a text message. If it is, processing flows to block 506; otherwise, processing branches to block 508.

At block 506, the received text message may be converted to an email message format. In one embodiment, where the text message is multiple related text messages, the multiple messages may be converted to a single email message. Processing then proceeds to block 508.

At block 508, the message is copied to an appropriate recipient's email inbox. Processing then flows to block 510, where the message may also be copied to a tab window that is arranged to display at least a portion of a history of a correspondence with the sender of the text message. Processing then flows to block 512, where a notification mechanism may be employed to alert the recipient of the received message. For example, in one embodiment, a tab within an email interface may be highlighted, change color, flash, or the like. The recipient may then select the received message, independent on what protocol the message was transmitted, using the email interface. Process 500 may then return to a calling process to perform other actions.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Illustrative Embodiment of a Client Interface

FIG. 6 shows one embodiment of an email interface that may be employed in practicing the invention, in accordance with various embodiments of the invention. Email interface 600 may include many more components than those shown. The components shown, however, are sufficient to disclose an illustrative embodiment for practicing the invention. Moreover, not all the components may be required to practice the invention and variations in the arrangement and type of the components may be made without departing from the spirit or scope of the invention.

As illustrated, email interface 600 shows a plurality of windows 602-604 that may be individually accessed using a tab mechanism (e.g., tabs 606-608). Such windows 602-604 enable a user to individually manage multiple message conversations. Thus, for example, window 602 includes folders 610 that enables access to various folders or boxes including, but not limited to inbox, draft, sent, outbox, trash, and the like. Moreover, windows 603-604 include compose icons 618-619 that allows a user to open an edit message window for use in composing a message.

In one embodiment, a number of windows 602-604 that are displayed on a screen may be limited. Thus, in one embodiment, a tab list 622 may be available that allows the user to select a window that may not be currently displayed, or even a window that is not currently in a forefront of other windows. Thus, for example, the user may select from tab list 622 to have window 604 be a first window being displayed rather than window 602, or the like.

Also shown in window 602 is selection icon 614 useable to select to send a message as a text message. Edit message window 612 and history window 611 are also illustrated, for a destination address 616. As seen, the user may provide a telephone number, for example, as an address for the message. Moreover, address selection 620 may expand to show a plurality of possible destination addresses to select from, to complete destination address 616. For example, in one embodiment, as a user enters characters into destination address 616, address selection 620 may display one or more selectable addresses based on matches of the characters to an address. The user may then select one of the displayed addresses to complete the destination address 616. In one embodiment, destination address 616 may also be autocompleted as the user enters the characters.

Edit message window 612 enables the user to compose a message, while history window 611 allows the user to view a history of correspondences with the destination address. In one embodiment, the history of correspondences may display a most recently received message. In one embodiment, contents of history window 611 are scrollable.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device for use in managing network communications, comprising:
a memory component for storing data; and
a processing component for executing data that enables actions, including:
receiving a request to send an email message;
receiving a destination address for the email message;
if the destination address is a mobile device, automatically converting the email message into at least one text message, and sending the at least one text message towards the destination address.

2. The network device of claim 1, wherein the actions further comprise:
copying at least one of the email message or the at least one text message to an email sent box.

3. The network device of claim 1, wherein the actions further comprise:
receiving a text response message to the sent at least one text message;
converting the text message into an email message format; and
copying the email formatted message into an email inbox.

4. The network device of claim 3, wherein the actions further comprise sending an alert when the email formatted message is copied to the email inbox.

5. The network device of claim 1, wherein the actions further comprise:
receiving a request to send another email message;
receiving another destination address for the other email message;
enabling a sender associated with the request to select to send the email message as a text message;
sending the message using a protocol based on the selection of the sender; and
copying the sent message to an email sent box associated with the sender.

6. The network device of claim 1, wherein converting the email message further comprises:
if the email message includes an attachment, inserting a Uniform Resource Locator (URL) into the at least one text message, wherein the URL enables a recipient to access the attachment.

7. The network device of claim 1, wherein the at least one text message further comprises at least one of a Short Message Service (SMS) message, Multimedia Messaging Service (MMS) message, or an Enhanced Message Service (EMS) message.

8. A processor readable medium that includes data, wherein the execution of the data provides for managing a communication over a network with a mobile device by enabling actions, including:
accessing an email interface;
employing the email interface to compose an email message;
selecting a destination address for the composed email message;
selecting to send the composed email message as an SMS message, wherein the email message is automatically converted to at least one SMS message, and is sent to the destination address using an SMS protocol; and
automatically copying the email message to an email sent box.

9. The processor readable medium of claim 8, wherein the email interface further comprises at least one of an email client application or a client web browser, and wherein the email interface is configured to display at least one window associated with the destination address.

10. The processor readable medium of claim 9, wherein at least one window includes a mechanism for notifying a user when a new message is received that is associated with the at least one window.

11. The processor readable medium of claim 8, wherein the actions further comprising:
if the destination address is associated with a mobile device, automatically converting the email message to the at least one SMS message.

12. The processor readable medium of claim 8, wherein the actions further comprising:
receiving an SMS response message to the at least one SMS message;
automatically converting the SMS response message into an email message format; and
automatically copying the email formatted message into an email inbox.

13. A method of managing a mobile communication over a network, comprising:
composing an email message;
selecting a destination address for the composed email message;
selecting to send the composed email message as an SMS message, wherein the email message is automatically converted to at least one SMS message, and is sent to the destination address using an SMS protocol; and
automatically copying the email message to an email sent box.

14. The method of claim 13, the method further comprising:
receiving an SMS response message to the at least one SMS message;
automatically converting the SMS response message into an email message format; and
automatically copying the email formatted message into an email inbox.

15. The method of claim 13, wherein selecting to send the composed email message further comprises at least one of automatically converting the email message based on the destination address being associated with a mobile device, or enabling a sender to select to send the email message as an SMS message.

16. The method of claim 13, wherein selecting the destination address further comprises using an auto-complete mechanism to select the destination address based on entering of at least one character into a destination address field.

17. A modulated data signal configured to include program instructions for performing the method of claim 13.

18. A mobile device for use in receiving a message over a network, comprising:
a processing component for executing data that enables actions, including:
receiving at least one text message, wherein the at least one text message was automatically converted from an email message prior to being received by the mobile device; and
providing a text message response, wherein the text message response is automatically converted to an email message format and the converted email message is copied into an email inbox of a recipient.

19. The client device of claim 18, wherein the at least one text message is converted from an email message further comprises, enabling a sender of the at least one text message to select to have the email message converted.

20. The client device of claim 18, wherein the at least one text message is converted from an email message further comprises, automatically converting the email message based on a destination address of the mobile device.

21. The client device of claim 18, wherein the at least one text message further comprises at least one of a Short Message Service (SMS) message, Multimedia Messaging Service (MMS) message, or an Enhanced Message Service (EMS) message.

22. The client device of claim 18, wherein copying the email message into an email inbox further comprises:
providing an alert to the recipient indicating that a new email message is received.
